(19) United States
(12) Patent Application Publication
(10) Pub. No.: US 2025/0113850 A1
(43) Pub. Date: Apr. 10, 2025

(54) Food Spice Reduction Formula

(71) Applicant: Vincent Ernest Engel, Holbrook, NY (US)

(72) Inventor: Vincent Ernest Engel, Holbrook, NY (US)

(21) Appl. No.: 18/482,875

(22) Filed: Oct. 7, 2023

(51) Int. Cl. A23L 27/00; A23D 9/007; A23J 3/08; A23J 3/10

(52) U.S. Cl. CPC A23L 27/84; A23D 9/007; A23J 3/08; A23J 3/10

(57) ABSTRACT

The invention is the use of the proteins whey and casein for the lightening of the effects brought about by the consumption of spicy foods. There are no current condiments on the market capable of lowering the effects from the consumption of spicy foods without alteration of the taste, therefore providing a new use for the aforementioned proteins.

### FIELD OF INVENTION

This invention is a condiment to put on food or inside of the mouth.

### BACKGROUND

People enjoy the taste of spicy foods, but can not tolerate the uncomfortable sensation that accompanies it. The most common method to reduce spice after consumption of spicy food would be to ingest milk. Some problems with milk being the method of spice reduction would lie in the fact that; Milk is not totally effective in the removal of spice and dairy products when consumed with spicy foods can cause stomach irritation. An invention that is effective in spice removal, and does not trigger an upset stomach is required.

### BRIEF SUMMARY OF INVENTION

The invention is a condiment to place on food or placed in the mouth that contains milk proteins casein or whey to reduce the effects of spicy foods.

### DETAILED DESCRIPTION

The condiment is made through the use of mixing Casein or Whey dairy proteins in powdered form. Olive oil or an oil base is used to dissolve the whey or casein into as well as the other ingredients. The condiment contains sucrose and calcium propionate as well. Casein or whey are mixed with olive oil in a ratio of 15 grams per 200 milliliters of oil. Calcium propionate should occupy three percent of the composition of the condiment. A pinch of sucrose in powdered form is added into the mixture as well. This mixture can be used to coat food to reduce the amount of spice felt by the consumer. The milk proteins are used to target capsaicin molecules present in spicy foods and complete the process of protein bonding to destroy capsaicin molecules to prevent the binding of capsaicin molecules to vanilloid receptors present in the body.

1. A mixture containing:
Casein or whey proteins for the use of reducing the effect of spicy food
